(19) United States
(12) Patent Application Publication
(10) Pub. No.: US 2002/0047060 A1
(43) Pub. Date: Apr. 25, 2002

(54) Kitchen appliance having a disc which is axially movable with respect to a processing tool

(76) Inventor: Jan Juriga, Klagenfurt (AT)

Correspondence Address: U.S. Philips Corporation, 580 White Plains Road, Tarrytown, NY, 10591, US

(21) Appl. No.: 09/973,357

(22) Filed: Oct. 9, 2001

(30) Foreign Application Priority Data
Oct. 11, 2000 (EP) 00890309.8

(51) Int. Cl. A47J 43/046

(52) U.S. Cl. 241/92; 241/282.1

(57) ABSTRACT

In a kitchen appliance (1) having a rotationally drivable drive section (15) and having a cutting device (16) supported on the drive section (15) the cutting device (16) consists of a holder (32) and a disc (17) which is axially movable with respect to the holder (17) and locked in rotation to the holder (32), and of an actuating knob (56) which is rotatable in tangential directions with respect to the holder (32) and the disc (17) and which is coupled to the disc (17), with the aid of which knob the disc (17) is axially movable, the coupling means (50, 60) being detachable from one another and the actuating knob (56) and the disc (32) being detachable from one another.

The invention relates to a kitchen appliance having a processing device which includes a holder and a processing tool held by the holder, and a disc which is axially movable with respect to the processing tool, and actuating means for axially moving the disc with respect to the holder.

The invention further relates to a processing device for a kitchen appliance, which device includes a holder and a processing tool held by the holder, and a disc which is axially movable with respect to the processing tool, and actuating means for axially moving the disc with respect to the holder.

A kitchen appliance of the type defined in the first paragraph having a processing device of the type defined in the second paragraph is known from the patent document U.S. Pat. No. 4,877,191 A. In the known construction the actuating means can be connected to the holder so as to form a unit and, after the unit has been assembled, a locking ring in the form of a torus, which is integral with the actuating means, engages in an annular groove in the holder, as a result of which the actuating means are locked and retained in a stable manner. With the known solutions this stable locking cannot be undone or disengaged, as a result of which the unit thus formed cannot be disassembled and, as a consequence, certain areas of the actuating means and of the holder are no longer accessible and therefore cannot be cleaned satisfactorily or cannot be cleaned at all.

It is an object of the invention to preclude the aforementioned problems and to provide an improved kitchen appliance and an improved processing device for a kitchen appliance.

In order to achieve the aforementioned object characteristic features have been provided in a kitchen appliance in accordance with the invention, so that such a kitchen appliance can be characterized in the manner defined hereinafter, namely:

A kitchen appliance having a rotationally drivable drive section and having a processing device which can be placed onto the drive section, which processing device includes a holder, which holder serves to and is adapted to hold a processing tool and is axially supported on the drive section and is rotationally drivable by the drive section, and which includes a disc which is locked in rotation to the holder and is movable with respect to the holder and is consequently axially movable with respect to the processing tool and is detachable from the holder, and which includes actuating means which are connected to the holder and which are coupled to the disc via coupling means and which are movable with respect to the holder and with respect to the disc and, when they are moved, provide an axial adjustment of the disc with respect to the holder, in which the coupling means between the disc and the actuating means include two coupling means elements which are detachable from one another, and in which the actuating means are detachable from the disc and from the holder.

In order to achieve the aforementioned object characteristic have been provided in a kitchen appliance in accordance with the invention, so that such a kitchen appliance can be characterized in the manner defined hereinafter, namely:

A processing device for a kitchen appliance, which processing device has the parts defined hereinafter, namely a holder, which holder serves to and is adapted to hold a processing tool and is axially supported on the drive section and is rotationally drivable by the drive section, and a disc which is locked in rotation to the holder and is movable with respect to the holder and is consequently axially movable with respect to the processing tool and is detachable from the holder, and actuating means which are connected to the holder and which are coupled to the disc via coupling means and which are movable with respect to the holder and with respect to the disc and, when they are moved, provide an axial adjustment of the disc with respect to the holder, in which the coupling means between the disc and the actuating means include two coupling means elements which are detachable from one another, and in which the actuating means are detachable from the disc and from the holder.

As a result of the provision of all the characteristic features of a kitchen appliance in accordance with the invention and all the characteristic features of a processing device in accordance with the invention it is achieved with such a kitchen appliance and with such a processing device that in a constructionally very simple and, in addition, cost-effective manner the actuating means can be separated and removed, when desired, from the disc and from the holder substantially without any effort, as a result of which the holder and the disc and the actuating means are each available separated from each other and, consequently, each of these three parts can be cleaned conveniently and thoroughly.

Further advantages can be obtained by the provision of the characteristic features as defined in the subclaims.

The aforementioned aspects as well as further aspects of the invention will be apparent from the example of an embodiment described hereinafter and will be elucidated with the aid of this example.

The invention will be described in more detail hereinafter with reference to an embodiment which is shown in the drawings by way of example but to which the invention is not limited.

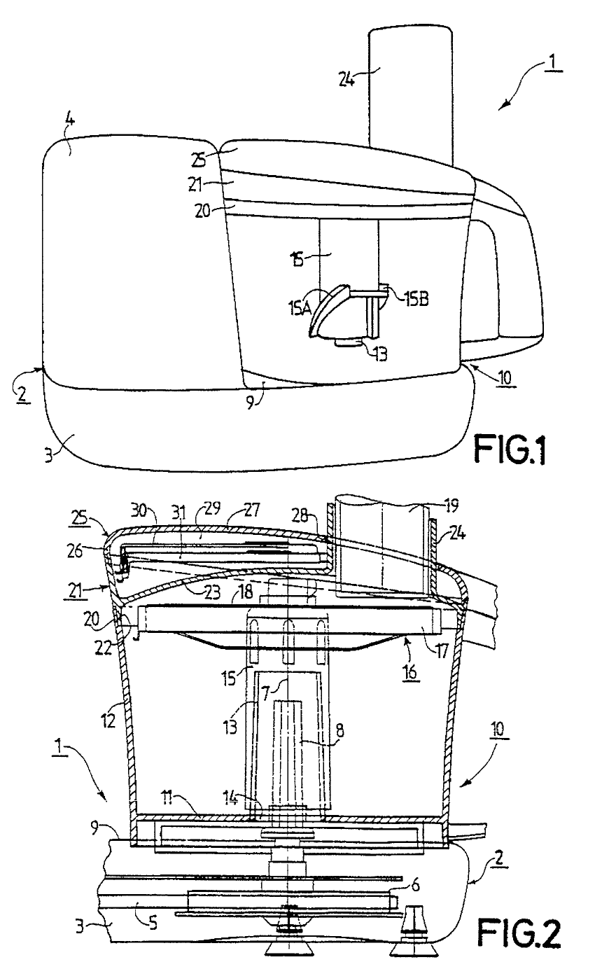

FIG. 1 shows diagrammatically and in side view a kitchen appliance embodying the invention.

FIG. 2 is a sectional view of a part of the kitchen appliance of FIG. 1, which kitchen appliance includes a processing device embodying the invention.

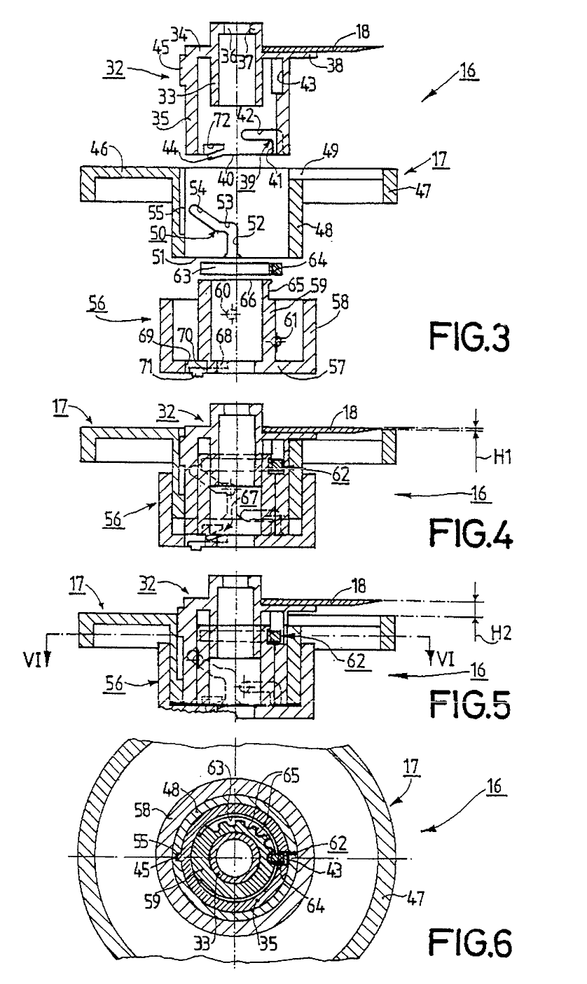

FIG. 3 is a somewhat diagrammatic sectional view of the processing device in an embodiment of the kitchen appliance shown in FIGS. 1 and 2, the processing device being shown in a disassembled condition.

FIG. 4 shows, similarly to FIG. 3, the processing device of FIG. 3, the processing device being shown in a condition during assembly of the processing device.

FIG. 5 shows, similarly to FIG. 4, the processing device of FIG. 4, the processing device being shown in a wholly assembled condition.

FIG. 6 shows the processing device of FIGS. 3, 4 and 5 in a sectional view taken on the line VI-VI in FIG. 5.

FIG. 1 shows a kitchen appliance 1. The kitchen appliance 1 has a housing which is substantially L-shaped in side view and which includes a base part 3 and a tower-shaped side part 4. The side part 4 accommodates a drive motor, not shown, by which drive means, which are mainly accommodated in the base part 3 and which are partly shown in FIG. 2, can be driven. The drive means include a drive belt 5, with the aid of which a pulley 6 is rotationally drivable about an axis 7. A drive mandrel 8 is rotationally drivable with the aid of the pulley 6 and extends through an upper wall 9 of the base part 3 of the housing 2 and which projects from the upper wall 9.

The kitchen appliance 1 further includes a container 10 which serves to contain substances to be processed. The container 10 has a bottom wall 11 and a basically imperforate circumferential wall 12 of substantially circular cross-sectional shape. In the area of the bottom wall 11 a sealing turret 13 is connected to the container 10 and surrounds a passage 14 in the bottom wall 11 of the container 10 and thereby prevents the substance to be processed from escaping through the passage 14 in the bottom wall 11. A drive turret 15 is placed over the sealing turret 13 and forms a drive element of the kitchen appliance, which drive turret is in driving engagement with the drive mandrel 8 in a manner not shown, as a result of which the drive turret 15 is rotationally drivable with the aid of the drive mandrel 8 when the container 10 is placed on the upper wall 9 of the base part 3. The drive turret 15, which has coupling ribs 15a and 15b as is shown in FIG. 1, can engage with and can drive different stirring tools and mixing tools as well as cutting tools. As is shown in FIG. 2, the drive turret 15 can engage with and can drive, inter alia, a substantially circular cutting device 16. The cutting device 16 forms a processing device of the kitchen appliance. The cutting device 16 is axially supported on the drive turret 15 and is rotationally drivable by the drive turret 15, as will be described in more detail hereinafter. The cutting device 16 has a substantially circular plastic disc 17, which is adapted to cooperate with a processing tool with which a metal cutter 18 cooperates, which cutter 18 forms the processing tool. By means of the cutting device 16 a substance to be sliced, for example a cucumber 19, which is shown schematically in FIG. 2, can be cut simply into slices, the slices falling into the container 10 and being collected therein.

At the side of the circumferential wall 12 remote from the bottom wall 11 the container 10 has a container rim 20. The container rim 20 borders an opening which gives access to the interior of the container.

For the closure of the container 10 the kitchen appliance 1 has a first cover configuration 21. The first cover configuration 21 has a cover rim 22, which cooperates with the container 10 in the area of its container rim 20, and a cover wall 23, which extends across the access opening to the container interior. A hollow cylindrical feed-in tube 24 projects from the cover wall 23, into which feed-in tube a substance to be sliced, for example the cucumber 19, can be inserted.

Advantageously, the kitchen appliance 1 shown in FIGS. 1 and 2 in addition has a second cover configuration 25. The second cover configuration 25 also has a cover rim 26. The second cover configuration 25 further has a cover wall 27, which extends across the cover wall 23 of the first cover configuration 21. The cover wall 27 of the second cover configuration 25 is formed with an opening 28, through which the feed-in tube 24, which projects from the first cover configuration 21, extends.

In the kitchen appliance 1 shown in FIGS. 1 and 2 the first cover configuration 21 and the second configuration 25 together bound a hollow space 29. In the present case, the hollow space 29 serves to and is adapted to accommodate two accessories of the kitchen appliance 1, namely to accommodate two cutters 30 and 31, which can optionally be attached to the disc 17 of the cutting device 16, instead of the cutter 18. The second cover configuration 25 has holding means, which are not shown in FIG. 2 and with the aid of which the two cutters 30 and 31 can be retained.

The processing device of the kitchen appliance 1, i.e. the cutting device 16, will be described in more detail hereinafter with reference to FIGS. 3 to 6.

The cutting device 16 has a holder 32. The holder 32 consists of a bearing sleeve 33 and an annular holder portion 34, which projects radially from the bearing sleeve 33, and of a connecting sleeve 35, which projects from the annular holder portion 34 in an axial direction.

The bearing sleeve 33 serves to support the holder 32 and, consequently, the entire cutting device 16 on the drive turret 15. With its bearing sleeve 33 the holder 32 is axially supported on the drive turret 15. With the aid of the drive turret 15 the holder 32 and, consequently, the entire cutting device 16 is rotationally drivable, namely in that a drive mandrel, which has a square cross-sectional shape and which projects from the drive turret 15, engages in a drive aperture 36 in the upper wall 37 of the bearing sleeve 33, which drive aperture also has a square cross-sectional shape. In known manner, the square cross-sectional shape provides a positive drive coupling; however, any other cross-sectional shape may be selected, such as for example hexagonal.

A holder arm 38 projects from the annular holder portion 34 in a radial direction. The cutter 18 is retained with the aid of the holder arm 38 and a part of the annular holder portion 34, the cutter 18 being secured to the holder arm 18 and the part of the annular holder portion 34 with the aid of metal or plastic screws or rivets, not shown.

The connecting sleeve 35 of the holder 32 has an L-shaped connecting slot 39, which has a first slot portion 41, which extends in an axial direction into the free end 40 of the connecting sleeve 35, and a second slot portion 42, which extends transversely to the first slot portion 41. Furthermore, a recess 43 is formed in the interior of the connecting sleeve 35. Moreover, a movable blocking member 44 is disposed in the area of the free end 40 of the connecting sleeve 35. In addition, an axial transmission fin 45 projects from the connecting sleeve 35 of the holder 32 in a radial direction.

The cutting device 16 further includes the disc 17 already mentioned hereinbefore. The disc 17 consists of an annular disc portion 46 and a peripheral sleeve 47, which surrounds the disc portion 46 in its peripheral area, and of a coupling sleeve 48, which projects axially from the disc portion 46 in its inner area. The inner diameter of the coupling sleeve 48 is slightly greater than the outer diameter of the connecting sleeve 35 of the holder 32, as a result of which the connecting sleeve 35 can readily be inserted into the coupling sleeve 48 of the disc 17.

The annular disc portion 46 of the disc 17 has a recess 49 adapted to receive the holder arm 38 and the cutter 18.

The coupling sleeve 48 of the disc 17 has a coupling slot 50, which has a first slot portion 52, which extends in the axial direction and which terminates in the free end 51 of the coupling sleeve 48, and a second slot portion 53, which extends transversely to the first slot portion 52, as well as a third slot portion 54, which is inclined with respect to the second slot portion 53. Furthermore, a transmission groove 55 is formed inside the coupling sleeve 48, which groove extends in the axial direction. The transmission groove 55 is adapted to cooperate with the transmission fin 45 of the holder 32. The holder 32 is locked in rotation to the disc 17 with the aid of the transmission fin 45 and the transmission groove 55. The disc 17 is movable with respect to the holder 32 and, consequently, with respect to the cutter 18 in axial directions, in order to enable the distance between the cutter 18 and the annular disc portion 46 of the disc 17 to be changed, as will be expounded on hereinafter. Furthermore, the holder 32 and the disc 17 are completely detachable from one another in that the connecting sleeve of the holder 32 is pulled out of the coupling sleeve 48 of the disc 17.

The cutting device 16 further has an actuating knob 56, which forms actuating means of the kitchen appliance 1. The actuating knob 56 consists of an annular knob portion 57 and of a coupling sleeve 58, which projects from the knob portion 57 in the peripheral area of the knob portion 57, and of a connecting sleeve 59, which is disposed inside the coupling sleeve 58. A coupling pin 60 projects radially from the coupling sleeve 58 inside the coupling sleeve 58. The coupling pin 60 serves to and is adapted to cooperate with the coupling slot 50 of the coupling sleeve 48 of the disc 17. A connecting pin 61 extends from the circumferential area of the connecting sleeve 59 in a radial direction. The connecting pin 61 serves to and is adapted to cooperate with the L-shaped connecting slot 39 in the connecting sleeve 35 of the holder 32. The actuating knob 56 is connected to the holder 32 with the aid of the connecting pin 61 and the connecting slot 39. The actuating knob 56 is coupled to the disc 17 via the coupling pin 60 and the coupling slot 50.

The actuating knob 56 is movable, i.e. rotatable, with respect to the holder 32 and with respect to the disc 17. During a movement, i.e. during a rotation of the actuating knob 56 with respect to the disc 17 and with respect to the holder 32, the actuating knob 56 in conjunction with its coupling pin 60, which cooperates with the third slot portion 54 of the coupling slot 50, produces an axial movement of the disc 17 with respect to the holder 32 and with respect to the actuating knob 56. By rotating the actuating knob 56 it is possible to set a minimum cutting height H1 (see FIG. 4) and a maximum cutting height H2 (see FIG. 5) between the cutter 18 and the annular disc portion 46 of the disc 17, as well as further cutting heights between the minimum cutting height H1 and the maximum cutting height H2.

It is to be noted that the outer diameter of the connecting sleeve 59 of the actuating knob 56 is slightly smaller than the inner diameter of the connecting sleeve 35 of the holder 32. Furthermore, the inner diameter of the coupling sleeve 58 of the actuating knob 56 is slightly greater than the outer diameter of the coupling sleeve 48 of the disc 17. In this way, it is achieved that the actuating knob 56 can be slid simply with its connecting sleeve 59 into the connecting sleeve 35 of the holder 32 and can be slid simply with its coupling sleeve 58 onto coupling sleeve 48 of the disc 17. Conversely, a simple removal of the actuating knob 56 from the disc 17 and from the holder 32 is also guaranteed.

To assemble the cutting device 16 the holder 32 is first inserted with its connecting sleeve 35 into the coupling sleeve 48 of the disc 17, the transmission fin 45 then engaging the transmission groove 55. Subsequently, the actuating knob 56 is moved in an axial direction towards the previously formed unit of the holder 32 and the cutting disc 17, the coupling pin 60 then engaging the first slot portion 52 of the coupling slot 50 and the connecting pin 61 engaging the first slot portion 41 of the connecting slot 39. As soon as the coupling pin 60 has reached the end of the first slot portion 52 of the coupling slot 50 and the connecting pin 61 has reached the end of the first slot portion 41 of the connecting slot 39, the actuating knob 56 is turned, as a result of which the connecting pin 61 engages the second slot portion 42 of the connecting slot 39 and the coupling pin 60 engages the second slot portion 53 of the coupling slot 50. After this, the holder 32 and the disc 17 as well as the actuating knob 56 form a constructional unit.

When the actuating knob 56 is turned further with respect to the disc 17 and the holder 32 the coupling pin 60 engages the third slot portion 54 of the coupling slot 50, the inclination of the third slot portion 54 causes the disc to be axially moved by the rotation of the actuating knob 56, in such a manner that the cutting height is increased.

It is to be noted that the cutting device 16 has latching means 62 (see particularly FIGS. 4, 5 and 6). The latching means 62 include a latching spring 63 which is bent into a circular shape and which has a latching projection 64 connected to it in its central area. A rounded front end of the latching projection 64 cooperates with latching recesses 65 formed in the area of the free end 66 of the connecting sleeve 59 of the actuating knob 56. The rear end portion of the latching projection 64 engages in the recess 43 in the connecting sleeve 35 of the holder 32, which inhibits a tangential movement of the latching projection 64 and, consequently, of the latching spring 63.

The cutting device 16 further includes security means 67 (see FIG. 4), with the aid of which an undesired separation of the actuating knob 56 from the disc 17 and from the holder 32 is precluded. The security means 67 include a movable blocking member 44 connected to the holder 32. The security means 67 further include a blocking member counterpart provided on the actuating knob 56. In the present case, a recess 68 is formed in the area of the annular knob portion 57 of the actuating knob 56, which recess is engaged by the blocking member 44 in the assembled condition (see FIG. 4) and has a lateral bounding wall 69 forming the blocking member counterpart and has a lower bounding wall 70 which is movable into the recess 68, for which purpose the lower bounding wall 70 carries a small push-button 71. Upon a movement of the lower bounding wall 70 of the recess 68 into the recess 68 the movable blocking member 44 can be moved out of the recess 68, namely into a recess 72 formed in the connecting sleeve 35, as a result of which the blocking member 44 is situated outside the path of movement of the lateral bounding wall 69, as a result of which the actuating knob 56 can be rotated so far, without being impeded by the blocking member 44, that the connecting pin 61 again lies in the area of the first slot portion 41 of the connecting slot 39 and the coupling pin 60 again lies in the area of the first slot portion 52 of the coupling slot 50, thus enabling the actuating knob 56 to be withdrawn from the disc 17 and from the holder 32 in an axial direction. After withdrawal of the actuating knob 56 the holder can be pulled out of the disc 17. Thus, it is achieved with the cutting device 16 that the cooperation of the blocking member 44 and of the blocking member counterpart formed by the lateral bounding wall 69 of the recess 68 inhibits a disengagement of the actuating knob 56 from the holder 32 and from the disc 17 and a cancellation of the cooperation of the blocking member 44 and of the blocking member counterpart formed by the lateral bounding wall 69 enables the actuating knob 56 to be detached from the holder 32 and from the disc 17.

Thus, the kitchen appliance 1 has the advantage feature that the coupling means between the disc 17 and the actuating knob 56 are formed by a pin-and-slot coupling (50, 60) and consequently have two coupling means elements, namely the coupling slot 50 and the coupling pin 60, which two coupling means elements (50, 60) which are simply disengageable from one another. Furthermore, the advantage feature is obtained that the actuating knob 56 can be detached from the disc 17 as well as from the holder 32.

As a result of the above construction of the kitchen appliance 1 and of the cutting device 16 for the kitchen appliance 1 it is achieved in a simple manner that the cutting device 16 can simply be disassembled into all its parts, as a result of which each of these parts can be cleaned thoroughly and conveniently, thereby guaranteeing optimum hygienic conditions.

In the kitchen appliance 1 the connecting sleeve 35 of the holder 32 has only one connecting slot 39 and the coupling sleeve 48 of the disc 17 has only one coupling slot 50. Accordingly, the actuating knob 56 has only one coupling pin 60 and only one connecting pin 61. Such a construction will function correctly if very good guiding conditions exist between the holder 32 and the disc 17 and the actuating knob 56. A particularly advantageous other embodiment of a kitchen appliance 1 and of a cutting device 16 for such a kitchen appliance 1 has two connecting slots 39 and two coupling slots 50, which slots 39, 50 each cooperate with respective pins 61 and 60. The two connecting slots 39 and the two coupling slots 50 as well as the pins 61, 60 which cooperate with these slots 39, 50 are arranged diametrically opposite each other, which is particularly advantageous.

Furthermore, it is to be noted that instead of security means 67 formed with the aid of a blocking member 44 and a lateral bounding wall 69 of a recess 68, simple latching means may be provided, which are disengageable when a given latching resistance has been overcome, namely by rotating the actuating knob 56 with respect to the holder 32.

Furthermore, it is to be noted that the latching means 62 may alternatively have a different construction. For example, a latching spring may be incorporated in the holder 32, so as to preclude an undesired loss of the latching spring, the latching spring incorporated in the holder then cooperating with latching recesses in the actuating knob.

1. A kitchen appliance (1) having a rotationally drivable drive section (15) and having a processing device (16) which can be placed onto the drive section (15),
which processing device includes a holder (32), which holder serves to and is adapted to hold a processing tool (18) and is axially supported on the drive section (15) and is rotationally drivable by the drive section (15), and
which includes a disc (17) which is locked in rotation to the holder (32) and is movable with respect to the holder (32) and is consequently axially movable with respect to the processing tool (18) and is detachable from the holder (32), and
which includes actuating means (56) which are connected to the holder (32) and which are coupled to the disc (17) via coupling means (50, 60) and which are movable with respect to the holder (32) and with respect to the disc (17) and, when they are moved, provide an axial adjustment of the disc (17) with respect to the holder (32),
in which the coupling means (50, 60) between the disc (17) and the actuating means (56) include two coupling means elements (50, 60) which are detachable from one another, and
in which the actuating means (56) are detachable from the disc (17) and from the holder (32).

2. A kitchen appliance (1) as claimed in claim 1,
in which the coupling means (50, 60) are formed by at least one pin-and-slot coupling (50, 60).

3. A kitchen appliance (1) as claimed in claim 1,
in which the holder (32) has a movable blocking member (44), and
in which the actuating means (56) have a blocking member counterpart (69), and
in which the cooperation of the blocking member (44) and of the blocking member counterpart (69) prevents the actuating means (56) from being detached from the holder (32) and
in which a cancellation of the cooperation of the blocking member (44) and of the blocking member counterpart (69) enables the actuating means (56) to be detached from the holder (32).

4. A kitchen appliance (1) as claimed in claim 3,
in which the actuating means (56) have a recess (68) which is engaged by the blocking member (44) and which has a lateral bounding wall (69) forming the blocking member counterpart (69) and which has a lower bounding wall (70) which is adapted to be movable into the recess (68), and
in which by a movement of the lower bounding wall (70) of the recess (68) into the recess (68) the movable blocking member 44 is movable out of the recess (68) and, consequently,
the actuating means (56) are disengageable from the holder (32).

5. A processing device (16) for a kitchen appliance (1),
which processing device (16) has the parts defined hereinafter, namely
a holder (32), which holder serves to and is adapted to hold a processing tool (18) and is axially supported on the drive section (15) and is rotationally drivable by the drive section (15), and
a disc (17) which is locked in rotation to the holder (32) and is movable with respect to the holder (32) and is consequently axially movable with respect to the processing tool (18) and is detachable from the holder (32), and
actuating means (56) which are connected to the holder (32) and which are coupled to the disc (17) via coupling means (50, 60) and which are movable with respect to the holder (32) and with respect to the disc (17) and, when they are moved, provide an axial adjustment of the disc (17) with respect to the holder (32),
in which the coupling means (50, 60) between the disc (17) and the actuating means (56) include two coupling means elements (50, 60) which are detachable from one another, and
in which the actuating means (56) are detachable from the disc (17) and from the holder (32).

6. A processing device (16) as claimed in claim 5,
in which the coupling means (50, 60) are formed by at least one pin-and-slot coupling (50, 60).

7. A processing device (16) as claimed in claim 5,
in which the holder (32) has a movable blocking member (44), and
in which the actuating means (56) have a blocking member counterpart (69), and
in which the cooperation of the blocking member (44) and of the blocking member counterpart (69) prevents the actuating means (56) from being detached from the holder (32) and
in which a cancellation of the cooperation of the blocking member (44) and of the blocking member counterpart (69) enables the actuating means (56) to be detached from the holder (32).

8. A processing device (16) as claimed in claim 7,
in which the actuating means (56) have a recess (68) which is engaged by the blocking member (44) and which has a lateral bounding wall (69) forming the blocking member counterpart (69) and which has a lower bounding wall (70) which is adapted to be movable into the recess (68), and
in which by a movement of the lower bounding wall (70) of the recess (68) into the recess (68) the movable blocking member 44 is movable out of the recess (68) and, consequently,
the actuating means (56) are disengageable from the holder (32).
